(19) United States
(12) Patent Application Publication
(10) Pub. No.: US 2024/0286654 A1
(43) Pub. Date: Aug. 29, 2024

(54) A Panel, Support Rib and Cantrail

(71) Applicant: VLR TECHNOLOGIES LIMITED, Warwickshire (GB)

(72) Inventors: Paul Salkeld, Warwickshire (GB); Adrian Howson, Warwickshire (GB); Shaun O'Brien, Warwickshire (GB)

(21) Appl. No.: 18/693,163

(22) PCT Filed: Sep. 20, 2022
(86) PCT No.: PCT/GB2022/052372

§ 371 Date: Mar. 19, 2024

(30) Foreign Application Priority Data
Sep. 20, 2021 (GB) 2113402.8

(51) Int. Cl. B61D 25/00; B61D 17/04

(52) U.S. Cl. CPC B61D 25/00; B61D 17/041; B61D 17/043

(57) ABSTRACT

A side wall assembly and associated cantrail of a light mass transit vehicle, the side wall assembly may be lightweight, strong and safe and the inclusion of panels in the assembly is easily adaptable. The cantrail may be more lightweight than typical cantrails while maintaining suitable rigidity and strength required to support a roof, and associated items mounted on a roof, and securely connect to a side wall assembly of a light mass transit vehicle.

This specification relates to light mass transit vehicles. In particular, although not exclusively, this specification relates to side wall assemblies and associated cantrails for light mass transit vehicles. Further, it is a non-exclusive object of this specification to provide a side wall assembly for a light mass transit vehicle which may be lightweight, strong and safe where the inclusion of panels in the assembly is easily adaptable and an improved cantrail that is more lightweight than typical cantrails while maintaining suitable rigidity and strength required to support a roof, and associated items mounted on a roof, and securely connect to a side wall assembly of a light mass transit vehicle.

Light mass transit vehicles (including light rail vehicles and very light rail vehicles) are typically designed to be reduced-weight versions of mainline (heavy) mass transit vehicles and travel with a lower payload at lower speeds. Light mass transit vehicles may be self-powered with an on-board battery. Self-powered light mass transit vehicles may no longer have the need for roof-mounted devices such as a pantograph, bow collector or trolley pole. This may provide operation on specialist light mass transit infrastructures and maintains an ability to interface with a mainline. Light mass transit vehicles may reopen disused rural and suburban lines and ensure continued operation of lines for which electrification is not yet present.

Considerations when designing a light mass transit vehicle may be desired payload and/or available infrastructure. These considerations may depend on the length of the light mass transit vehicle. For example, some light mass transit vehicles may be longer so to carry a higher payload, although these vehicles may sometimes be too long for the available infrastructure.

Light mass transit vehicle side wall panels are a factor of vehicle length and are generally formed as a single carriage piece made from an aluminium sheet fixed to a side wall skeleton. Further, side wall panels normally provide support for the light mass transit vehicle roof and any roof mounted devices. WO2018146083 discloses an example of a lightweight rail vehicle body with side wall panels.

It may be difficult to add and/or remove panels from a side wall assembly to form vehicles of different lengths while maintaining structural safety of the vehicle. Further, as the roof support members may no longer need to support roof-mounted devices, current roof support members and side wall assemblies may not be suitable for supporting a reduced load.

There is, therefore, a need to provide a light mass transit vehicle that can be adapted for a desired payload on an available infrastructure while maintaining safety and structural standards, which alleviates one or more problems associated with the prior art.

Further, roof support members (for example, cantrails) are typically known as being a piece of metal or timber supporting the roof of a railway carriage or other such elongated vehicle. An example of such a cantrail is disclosed in Australian patent application number 30064/89. Structural requirements of cantrails typically include enough strength and rigidity to support a roof and any associated items typically found on a roof, such as a pantograph, bow collector or trolley pole. Therefore, typical cantrails are made from high-strength steel or aluminium alloys and may include additional iron joining inserts such as that disclosed in AU30064/89. In a light mass transit vehicle, these structures add a relatively high weight to the overall vehicle weight providing a less efficient overall vehicle (higher mass to move) and a less stable vehicle (higher centre of mass). Further typically, cantrails need to be supported along the length of a carriage, typically by carriage side walls. It may be difficult to remove or add carriage side walls, for maintenance or assembly for example, without compromising the roof support structure.

There is, therefore, a need to provide a cantrail which alleviates one or more problems associated with the prior art.

Accordingly, a first aspect provides a panel for a side wall assembly of a light mass transit vehicle, comprising: a first side portion comprising one or more connecting members; a second side portion comprising one or more connecting members; a top portion separating the first and second side portions and comprising a plurality of protrusions configured to interlock with a roof support member of the vehicle, each protrusion extending substantially from the first side portion to the second side portion; and a bottom portion configured to connect to a base support member of the vehicle.

The connecting members may be configured to connect to attachment members of a support rib.

The one or more connecting members of the first side portion may be three or more connecting members and may be spaced in three distinct groups.

The one or more connecting members of the second side portion may be three or more connecting members and may be spaced in three distinct groups.

The three distinct groups may comprise two groups with one connecting member and one group of more than one connecting members.

The one group of more than one connecting members may comprise eight connecting members.

Each protrusion may further comprise one or more recesses.

The plurality of protrusions may be three protrusions.

The three protrusions may be equally spaced from each other.

The plurality of protrusions may originate from a common plane.

The top portion may further comprise one or more apertures for fixing means for the roof support member.

A centre axis of at least one of the one or more apertures may run through at least one of the plurality of protrusions.

The bottom portion may further comprise one or more apertures for fixing means for the base support member.

Three or more of the one or more apertures may be arranged in a line at a 35 to 55 degree angle to the vertical.

The panel may further comprise a seat rail extending substantially from the first side portion to the second side portion.

The panel may further comprise a trapezoidal window wherein a top base side is longer than a bottom base side.

The connecting members may be keyed for inserting into the attachment members of a support rib.

A second aspect provides a support rib for a side wall assembly of a light mass transit vehicle, comprising: a first side portion comprising one or more attachment members; a second side portion comprising one or more attachment members; a top portion separating the first and second side portions and comprising a plurality of protrusions configured to interlock with a roof support member of the vehicle, each protrusion extending from the first side portion to the second side portion; and a bottom portion configured to connect to a base support member of the vehicle.

The attachment members may be configured to attach to connecting members of a panel.

The first and second side portions may further comprise any of the features of the first and second side portions of the panel for connecting the support rib to the panel.

The top portion may further comprise any of the features of the top portion of the panel for connecting to the roof support member.

The bottom portion may further comprise one or more apertures for fixing means for the base support member.

The attachment members may be keyed for receiving the connecting members of the panel.

A single support rib may be configured to connect to two of the panels.

A third aspect provides a vehicle comprising the panel and the support rib.

A fourth aspect provides a cantrail for a light mass transit vehicle, a first portion of the cantrail comprising a plurality of recesses or protrusions for engaging a plurality of protrusions or recesses respectively on a side wall assembly, each recess or protrusion extending a length of the cantrail, wherein two or more of the cantrail recesses or protrusions are connected to internal support ribs of the cantrail such that a stress force acting at the first portion of the cantrail is dispersed to a second portion of the cantrail.

The plurality of recesses or protrusions may be in the form of keys.

The recesses or protrusions may be trapezoid shaped.

An internal angle of the trapezoidal recesses or protrusions may be 35 to 55 degrees or 125 to 145 degrees.

An internal angle of the trapezoidal recesses or protrusions may be 45 or 135 degrees.

The cantrail may further comprise a plurality of internal chambers defined by the support ribs.

The cantrail may be formed of a metal or fibre-reinforced composite.

The metal may be aluminium or the fibre-reinforced composite may be CFRP respectively.

The plurality of recesses or protrusions may be three recesses or protrusions on a single cantrail.

The three recesses or protrusions may be equally spaced away from each other on a first surface of the cantrail.

A fifth aspect provides a computer-readable medium comprising instructions that when executed instructs a material deposition device to form the cantrail of any preceding claim.

A sixth aspect provides a body for a light mass transit vehicle, including: at least one panel for a side wall assembly of a light mass transit vehicle, the or each panel comprising: a first side portion comprising one or more connecting members;
a second side portion comprising one or more connecting members;
a top portion separating the first and second side portions and comprising a plurality of protrusions or recesses configured to interlock with a roof support member of the vehicle, each protrusion or recess extending substantially from the first side portion to the second side portion; and a bottom portion configured to connect to a base support member of the vehicle; and further including at least one cantrail for a light mass transit vehicle, a first portion of the cantrail comprising a plurality of recesses or protrusions for engaging a plurality of protrusions or recesses respectively on the side wall assembly, each recess or protrusion extending a length of the cantrail, wherein two or more of the cantrail recesses or protrusions are connected to internal support ribs of the cantrail such that a stress force acting at the first portion of the cantrail is dispersed to a second portion of the cantrail, wherein the cantrail is the roof support member and is configured to interlock the or each panel via complementary protrusions or recesses.

The body may further include at least one support rib for a side wall assembly of a light mass transit vehicle, the or each support rib including a top portion, the top portion including the protrusions or recesses and configured to interlock with the at least one cantrail.

A seventh aspect provides a light mass transit vehicle including the body.

An eighth aspect provides a light mass transit vehicle including at least one panel.

A ninth aspect provides a light mass transit vehicle including at least one support rib.

A tenth aspect provides a light mass transit vehicle including the cantrail.

Embodiments of the invention are described, by way of example, with reference to the accompanying drawings, in which:

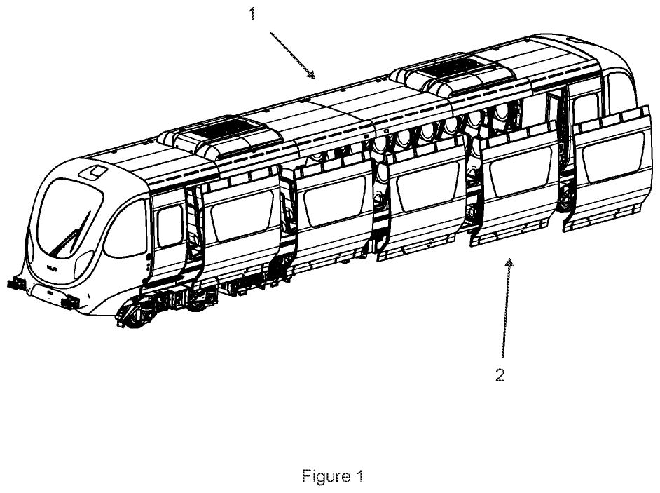

FIG. 1 shows a perspective view of a light mass transit vehicle including panels for a side wall assembly;

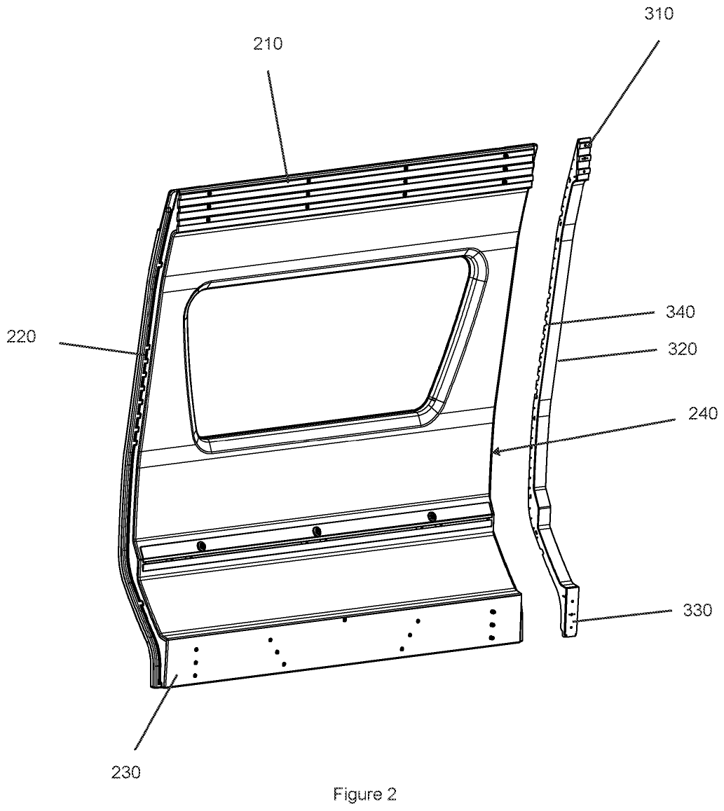

FIG. 2 shows perspective views of an inside of a panel and support rib for a side wall assembly of a light mass transit vehicle;

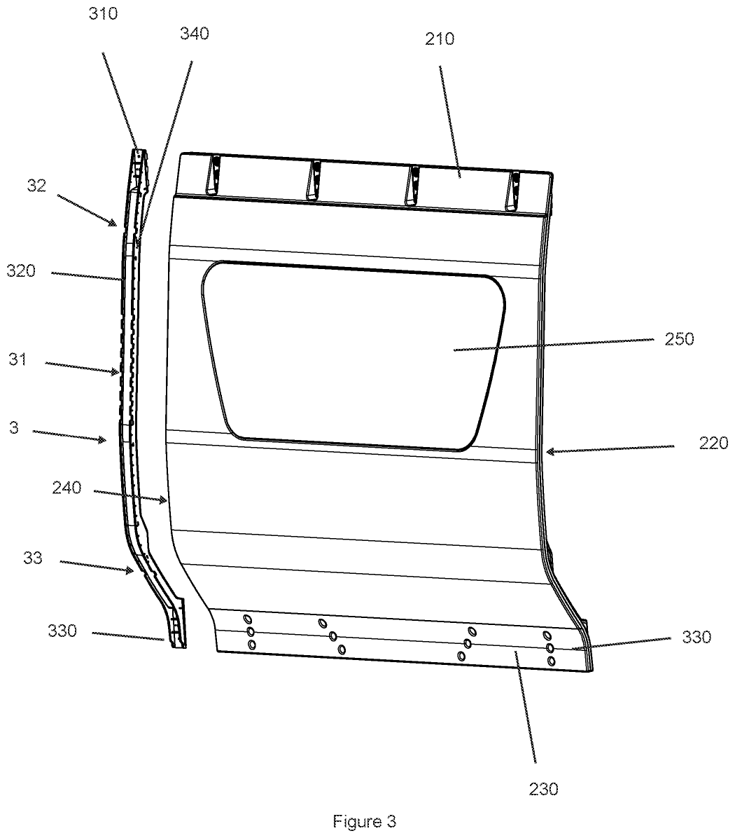

FIG. 3 shows perspective views of an outside of a panel and support rib for a side wall assembly of a light mass transit vehicle;

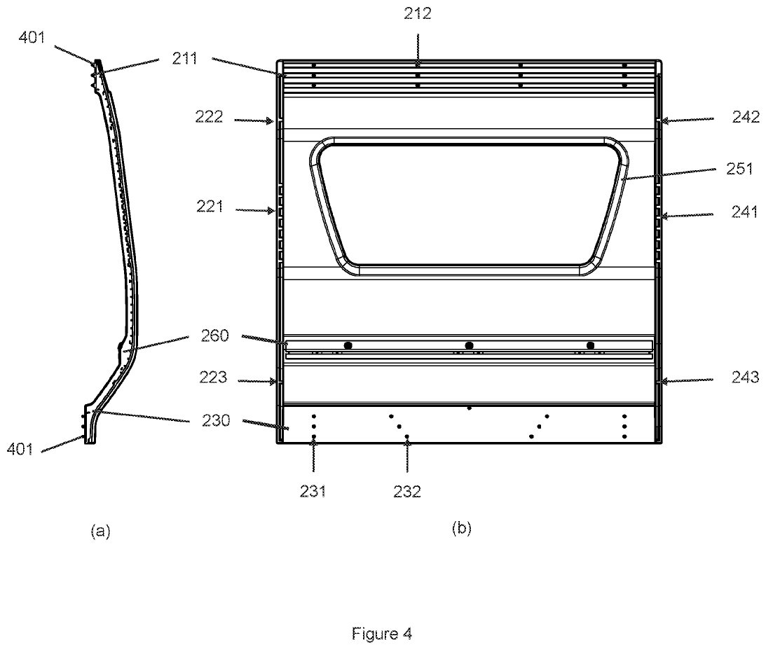

FIG. 4 shows (a) a side view and (b) an inside front view of a panel for a side wall assembly of a light mass transit vehicle;

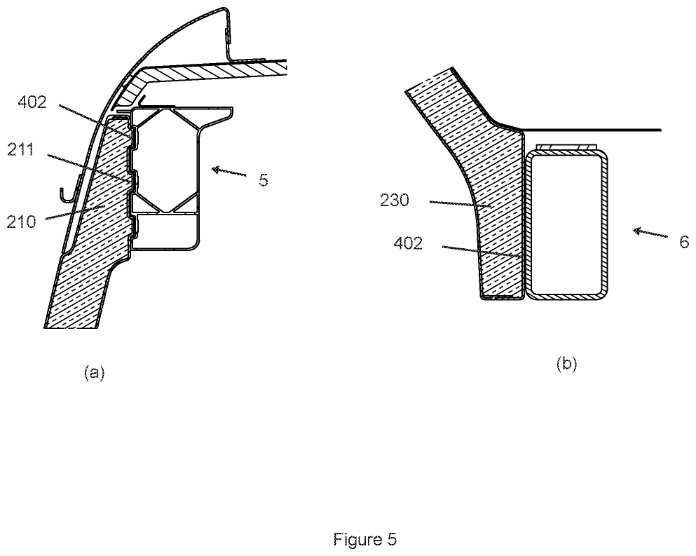

FIG. 5 shows (a) a top portion of a panel or support rib interlocking with a roof support member of a light mass transit vehicle and (b) a bottom portion of a panel or support rib in connection with a base support member of a light mass transit vehicle;

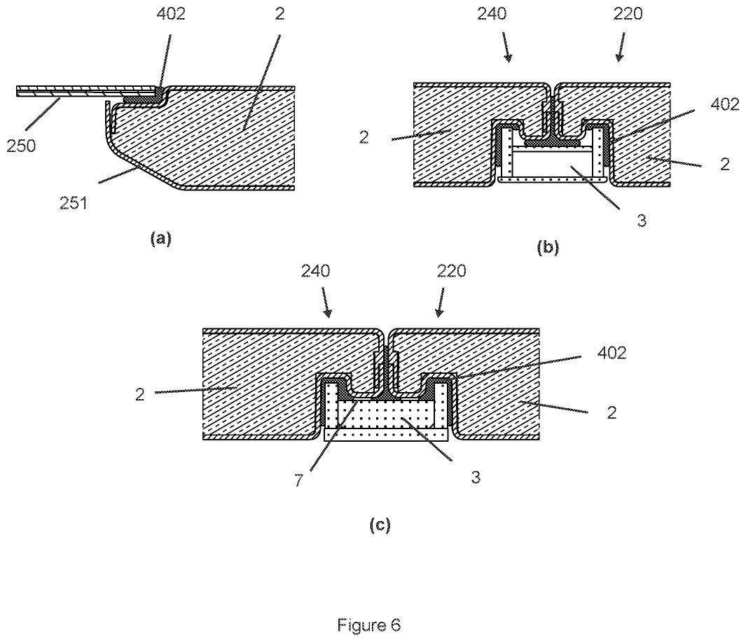

FIG. 6 shows (a) an interface between a panel and window, (b) an interface between two panels and a single support rib, and (c) another interface between two panels and a single support rib.

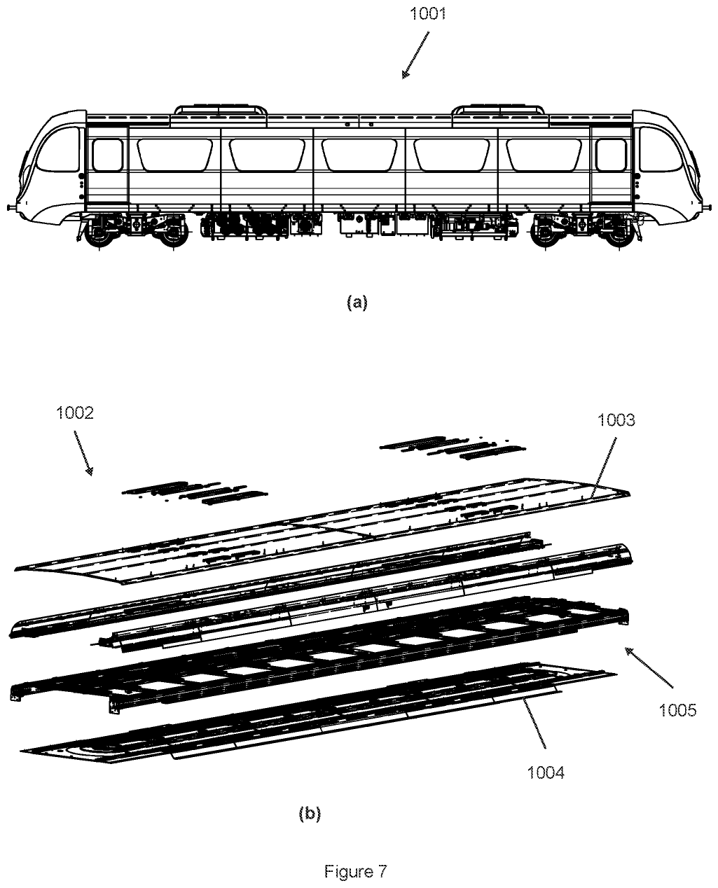

FIG. 7 shows an example of (a) a light mass transit vehicle and (b) a roof portion of a light mass transit vehicle;

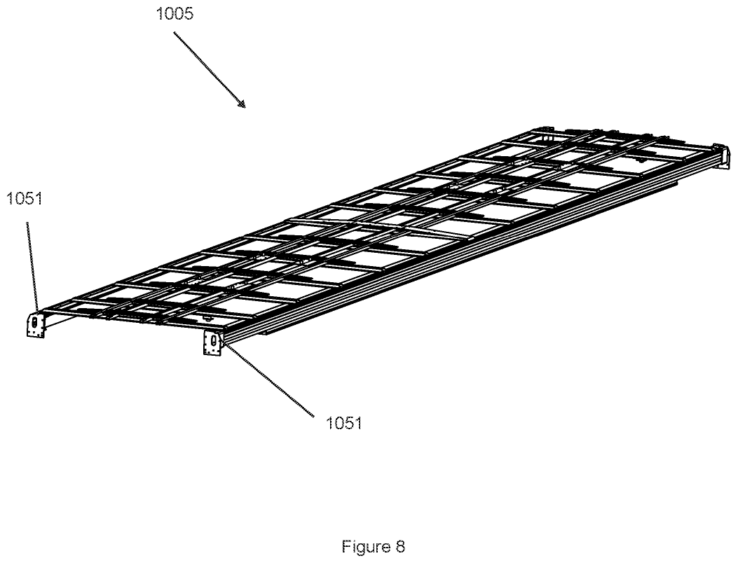

FIG. 8 shows an example of a roof support structure of the light mass transit vehicle; and

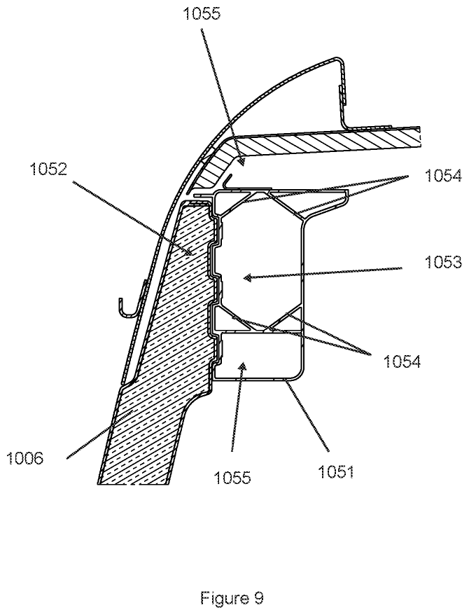

FIG. 9 shows an example of an improved cantrail.

Referring firstly to FIG. 1, there is shown a light mass transit vehicle (1) comprising a panel (2) for a side wall assembly. The panel (2) may be one of a plurality of panels (2) in a side wall assembly. The panel (2) may be universal such that they may be used at a front end of the light mass transit vehicle (1) or a rear end of the light mass transit vehicle (1). It may be advantageous to increase or decrease the number of panels included in the side wall assembly of the light mass transit vehicle to increase or decrease the payload of the light mass transit vehicle. It may be further advantageous in order to meet the needs of the infrastructure available to the light mass transit vehicle.

The mass transit vehicle (1) may be a light rail vehicle or a very light rail vehicle. Further, the mass transit vehicle (1) may be a wheeled vehicle.

Referring now to FIGS. 2, 3 and 4, a panel (2) comprises a first side portion (220). The first side portion (220) may span an edge of the panel (2). The edge may be a vertical edge. The first side portion (220) may comprise a flange. One or more connecting members (221, 222, 223) are included on the first side portion (220). The connecting members (221, 222, 223) may be at least partially located on the flange. It may be advantageous to provide connecting members on a first side portion of a panel to provide means for the panel to align and connect to another panel in a side wall assembly. Further, this may increase speed and ease of assembly of the light mass transit vehicle while ensuring a strong and safe connection.

The panel (2) further comprises a second side portion (240). The second side portion (240) may span an edge of the panel (2). The edge may be a vertical edge. Further, the second side portion (240) may comprise a flange. One or more connecting members (241, 242, 243) are included on the second side portion (240). The connecting members (241, 242, 243) may be at least partially located on the flange. The second side portion (240) may be an edge of the panel (2) parallel to an edge of the first side portion (220). It may be advantageous to include a second side portion with connecting members so that the panel can align and connect to two further panels, one either side, in a side wall assembly. This may further increase speed and ease of assembly of the light mass transit vehicle while ensuring a strong and safe connection.

The one or more connecting members (221, 222, 223) of the first side portion (220) may be three or more connecting members. It may be advantageous to provide more connecting members to increase ease of alignment and security of the connection. Further, the one or more connecting members may be spaced in three distinct groups (221, 222, 223). It may be further advantageous to space the connecting members in groups to disperse stress points when the one or more connecting members on the first side portion are under a load.

The one or more connecting members (241, 242, 243) of the second side portion (240) may be three or more connecting members. It may be advantageous to provide more connecting members to increase security of the connection. Further, the one or more connecting members may be spaced in three distinct groups (241, 242, 243). It may be further advantageous to space the connecting members in groups to disperse stress points when the one or more connecting members on the second side portion are under a second load.

The three distinct groups (241, 242, 243) may comprise two groups with one connecting member (222, 223, 242, 243) and one group of more than one connecting members (221, 241). For example, the one group of more than one connecting members (221, 241) may comprise eight connecting members. It may be advantageous to include more than one connecting member in a group for areas under high stresses or loads on the first and/or second side portion compared with another area.

The one or more connecting members (221, 222, 223, 241, 242, 243) may be configured as a male type connector. The male type connector may include a protrusion. The protrusion may be for insertion into a female type connector. It may be advantageous to provide a secure connection. Each protrusion may include a ramped portion to aid alignment during connecting of the panel.

Further examples of connecting members may include keys, engaging members, fasteners, catches and/or hooks. Keys may include connecting members that are limited to a particular shape in order to provide a connection and/or alignment of the panel. An example of a key may be a 221 keyway.

The panel (2) further comprises a top portion (210). The top portion (210) may span an edge of the panel (2). The edge may be a horizontal edge relative to the first and second portions (220, 240). The top portion (210) separates the first and second side portions (220, 240). The top portion (210) may be located at a common end of the first and second side portions (220, 240). The top portion (210) may include a flat surface. The flat surface may span from the first portion (220) to the second portion (240). It may be advantageous to provide a flat surface on the top member to provide a datum for surface features and a uniform mating surface.

The top portion (210) may comprise one or more apertures (212). For example, the one or more apertures (212) may be twelve apertures. Each aperture may run through the panel (2) from an outside to an inside of the panel (2). The one or more apertures (212) may be grouped into sets of three apertures. Each group may include three vertically aligned apertures (212). Accordingly, the top portion (210) may include four sets of three apertures (212). The four sets of three apertures (212) may be evenly spaced over the top portion (210). It may be advantageous to provide apertures to provide fixing means to fix the top portion to a support member of the light mass transit vehicle. Examples of fixing means includes bolts/nuts, rivets and screws.

The panel (2) further comprises a bottom portion (230). The bottom portion (230) may span an edge of the panel (2). The edge may be a horizontal edge relative to the first and second portions (220, 240). Further, the bottom portion (230) edge may be parallel to an edge of the top portion (210). The bottom portion (230) may separate the first and second side portions (220, 240). The bottom portion (230) may be located at a common end of the first and second side portions (220, 240). The common end may be a different end to the top portion (210). The bottom portion (230) may include a flat surface. The flat surface may span from the first portion (220) to the second portion (240). It may be advantageous to provide a flat surface on the bottom member to provide a datum for surface features and a uniform mating surface.

The bottom portion may further comprise one or more apertures (231, 232). The one or more apertures (231, 232) may include twelve apertures. Three or more of the one or more apertures may be arranged in a vertical line (231). Three or more of the one or more apertures may be arranged in a line at a 35 to 55 degree angle to the vertical line (232). In particular, the three or more of the one or more apertures may be arranged in a line at a 45 degree angle to the vertical line (232). The one or more apertures (231, 232) may include four groups of three apertures. The four groups of three apertures may include two groups arranged in a vertical line (231) and two groups arranged at a 35 to 55 degree angle to the vertical line (232). An imaginary line passing through the group of three or more apertures arranged in a line at a 35 to 55 degree angle to the vertical (232) may intercept with an imaginary line passing through a second group of three or more apertures arranged in a line at a 35 to 55 degree angle to the vertical (232). The two groups arranged at a 35 to 55 degree angle to the vertical line (232) may be located between the two groups arranged in a vertical line (231). It may be advantageous to arrange one or more apertures in such a way so that when in use, stress points are dispersed.

The panel (2) may also include a seat rail (260). The seat rail (260) may extend substantially from the first side portion (220) to the second side portion (240). The seat rail (260) may be for supporting a seating assembly for use by passengers of the light mass transit vehicle (1). The seat rail (260) may be located closer to the bottom portion (230) than the top portion (210).

The panel may comprise a trapezoidal window (250). The trapezoidal window (250) may include two base sides and two leg sides. The trapezoid may be an inverted trapezoid. A top base side may be longer than a bottom base side. It may be advantages to provide a stronger, sturdier window and/or stronger, sturdier panel. An intersection of a base side with a leg side may comprise a curved portion. For example, the trapezoidal window (250) may comprise four curved corners. It may be advantageous to provide curved corners to increase strength of the window and/or panel.

The panel (2) may be substantially formed of a first material. The first material may be a fibre-reinforced composite. Examples of fibre-reinforced composites include carbon fibre. A fibre-reinforced composite may provide a lightweight, ridged, and strong material with means for storing wiring, pipes and/or other parts of the side wall assembly within the panel. Further, as the roof support members may no longer need to support roof-mounted devices such as a pantograph, bow collector or trolley pole, it may be advantageous to provide a lightweight side wall assembly that is suitable for supporting a reduced load.

Referring to FIG. 5, the top portion (210) comprises a plurality of protrusions (211). The plurality of protrusions (211) are configured to interlock with a roof support member (5). The roof support member (5) may include a plurality of recesses for receiving the plurality of protrusions (211). The roof support member (5) may extend an entire length of the light mass transit vehicle (1). The plurality of protrusions (211) may be in the form of keys. The protrusions (211) may be trapezoid shaped. It may be advantageous to align the top portion with the roof support member and/or increase the security of the fixing between the panel and the roof support member. This may provide easy assembly of the panel and ensure a strong and safe panel connection when the light mass transit vehicle is in use.

An internal angle of the trapezoidal protrusions may be between 35 to 55 degrees or between 125 to 145 degrees. In particular, an internal angle of the trapezoidal protrusions (211) may be 45 or 135 degrees. It may be advantageous to reduce local stresses and provide a stronger connection of the panel to the roof support member.

The roof support member (5) may comprise a plurality of internal chambers. The roof support member (5) may be a cantrail. The roof support member may formed of a metal or fibre-reinforced composite. The metal may be aluminium. It may be advantageous to reduce the weight of the roof support member. Further, as the roof support member may no longer need to support roof-mounted devices such as a pantograph, bow collector or trolley pole, it may be advantageous to provide a lightweight roof support member that is suitable for supporting a reduced load.

Each of the plurality of protrusions (211) extends substantially from the first side portion (220) to the second side portion (240). Further, each of the plurality of protrusions (211) may extend from the first side portion (220) to the second side portion (240). Accordingly, the plurality of protrusions (211) may span the entire length of the panel (2). It may be advantageous for the panel to interlock with the roof support member along the entire length of the panel to provide a more secure interlock.

The plurality of protrusions (211) may be three protrusions. The three protrusions may be equally spaced from each other. The three protrusions may be spaced vertically. It may be advantageous to provide a more secure interlock.

The plurality of protrusions (211) may originate from a common plane. The common plane may lie on a flat surface of the top portion (210). Three or more of the plurality of protrusions (211) may protrude the same amount from the common plane.

A centre axis of at least one of the one or more apertures (212) may run through at least one of the plurality of protrusions (211). The one or more apertures (212) may provide fixing means to the roof support member (5). Accordingly, fixing means may run through the top portion (210) and the plurality of protrusions (211) and into the roof support member (5). Fixing means may be combined with adhesive layer (402). The adhesive layer (402) may cover a mating surface of the top portion (210). It may be further advantageous to provide a secure and safe fixing of the panel (2) to the roof support member (5).

Referring in particular back to FIG. 4(b), the bottom portion (230) is configured to connect to a base support member (6). The base support member (6) may extend an entire length of the light mass transit vehicle (1). The base support member (6) may be hollow. The base support member (6) may be a solebar. The base support member (6) may be formed of a second material. The second material may a metal. The metal may be a steel or alloy steel. It may be advantageous to provide a base support member heavier than the side walls and/or roof support member to provide a strong and rigid foundation for supporting the side walls and/or roof support member. Further, a heavier base support member may provide a lower centre of gravity and a sturdier light mass transit vehicle.

The one or more apertures (231, 232) in the bottom portion (230) may provide fixing means for the base support member (6). Fixing means may run through the bottom portion (230) and into the base support member (6). Fixing means may be combined with adhesive layer (402). The adhesive layer (402) may cover a mating surface of the bottom portion (210). The mating surface of the bottom portion (230) may be a flat surface. It may be further advantageous to provide a secure and safe fixing of the panel (2) to the base support member (6).

Referring to FIG. 6(a), the trapezoidal window (250) may connect to the panel (2). The panel (2) may include a window recess for the trapezoidal window (250). The trapezoidal window (250) may be fixed to the panel (2) using adhesive (402). The adhesive may cover a surface of the window recess. The panel (2) may include a window chamfer or curve (251). It may be advantageous to provide a safer and sturdier window.

Referring to FIG. 6(b) and FIGS. 2, 3 and 4, the connecting members (221, 222, 223, 241, 242, 243) may be configured to connect to attachment members (31, 32, 33) of a support rib (3).

A support rib (3) for a side wall assembly of a light mass transit vehicle (1) is provided. The support rib (3) may be one of a plurality of support ribs (3) in a side wall assembly for a light mass transit vehicle (1). The support ribs (3) may be universal such that they may be used at a front end of the light mass transit vehicle (1) or a rear end of the light mass transit vehicle (1). It may be advantageous to increase or decrease the number of support ribs included in the light mass transit vehicle to increase or decrease the number of panels included in the side wall assembly of the light mass transit vehicle. It may be further advantageous in order to meet the needs of the infrastructure available to the light mass transit vehicle.

The support rib (3) comprises a first side portion (320). The first side portion (320) comprises one or more attachment members (31, 32, 33). The attachment members (31, 32, 33) may be configured to attach to connecting members (221, 222, 223, 241, 242, 243) of a panel (2). The first side portion (320) may span an edge of the support rib (3). The edge may be a vertical edge. It may be advantageous to provide attachment members on a first side portion of a support rib to provide means for the support rib to align and connect to a panel in a side wall assembly. Further, this may increase speed and ease of assembly of the light mass transit vehicle while ensuring a strong and safe connection.

The support rib (3) further comprises a second side portion (340). The second side portion (340) comprises one or more attachment members (31, 32, 33). The second side portion (340) may span an edge of the support rib (3). The edge may be a vertical edge. The second side portion (340) may be an edge of the support rib (3) parallel to an edge of the first side portion (320). It may be advantageous to include a second side portion with attachment members so that the support rib can align and connect to two panels, one either side, in a side wall assembly. This may further increase speed and ease of assembly of the light mass transit vehicle while ensuring a strong and safe connection.

The first and second side portions (320, 240) of the side rib (3) may further comprise any of the features of the first and second side portions (220, 240) of the panel (2) for connecting the support rib (3) to the panel (2). It may be advantageous to provide a secure connection between the panel and support rib.

Comparative with the top portion (210) of the panel (2), the support rib (3) further comprises a top portion (310). The top portion (310) separates the first and second side portions (320, 240) of the support rib (3). The top portion (310) comprises a plurality of protrusions (211). The protrusions (211) are configured to interlock with a roof support member (5). The roof support member (5) may be the same roof support member (5) for the panel (2). Each protrusion (211) extends from the first side portion (320) to the second side portion (340). The top portion (310) of the support rib (3) may further comprise any of the features of the top portion (210) of the panel (2) for connecting to the support rib (3) to the roof support member (5).

Comparative with the bottom portion (230) of the panel (2), a bottom portion (330) of the support rib (3) is configured to connect to a base support member (6). The base support member (6) may be the same base support member (6) for the panel (2). The bottom portion (330) may further comprise one or more apertures for fixing means for a base support member (6). The fixing means may be the same as used for the panel (2).

The one or more attachment members (31, 32, 33) may be configured as a female type connector. The female type connector may include a recess. The recess may be for receiving a male type connector. It may be advantageous to provide a secure connection.

The support rib (3) may be formed of a first material and second material. The first material may be a fibre-reinforced composite. The second material may be a metal. The metal may comprise aluminium and/or steel. A fibre-reinforced composite may provide a lightweight, ridged, and strong material with means for storing wiring, pipes and/or other parts of the side wall assembly within the support rib.

A single support rib (3) may be configured to connect to two of the panels (2). The one or more connecting members (221, 222, 223) on the first side portion (220) of a first panel (2) may connect with the attachment members (31, 32, 33) on the first side portion (320) of the support rib (3). Further, the one or more connecting members (241, 242, 243) on the second side portion (240) of a second panel (2) may connect with the attachment members (31, 32, 33) on the second side portion (340) of the support rib (3).

A layer of adhesive (402) may be applied to the support rib (3). The layer of adhesive (402) may be applied in three locations on the support rib (3). The three locations may be where a panel (2) mates with another panel (2) and/or the support rib (3). Connecting members and/or a flange of the first and second panels (2) may then be inserted into the support rib (3). The first and second panels (2) may be fixed to the support rib (3) via the adhesive layer (402). Further fixing means, for example, bolts, rivets and/or screws may be used to further secure the panels (2) to the support rib (3). The connection may be a rigid connection. It may be advantageous to provide a fast, easy and secure assembly of panels in a side wall assembly for a light mass transit vehicle (1).

Referring to FIG. 6(c), another interface between two panels (2) and a single support rib (3) may be provided. A seal (7) may be further provided between the panels (2) and the support rib (3). The seal (7) may be weather-proof. It may be advantageous to provide a seal to limit the number of contaminants entering the light vehicle. Further, the seal may reduce the level of noise entering the inside of the light mass transit vehicle. The seal may be formed of an elastomer.

A vehicle (1) comprising the panel (2) and the support rib (3) is also provided. The vehicle (1) may comprise a plurality of panels (2) and support ribs (3). The support rib (3) may be configured to connect to a head and/or tail module of the vehicle (1).

Further panels (2) and support ribs (3) may be alternately included to form a side wall assembly of the vehicle (1). The vehicle (1) may comprise two symmetrical side wall assemblies.

The vehicle (1) may be a light rail vehicle or a very light rail vehicle. Further, the vehicle (1) may be a wheeled vehicle. It may be advantageous to provide a strong and safe side wall assembly where the number of panels included in the assembly is easily adaptable. In particular, it may be advantageous to provide an adaptable wheeled vehicle that does not require an existing infrastructure.

It will be appreciated that a panel (2) may include a first side portion (220) comprising one or more connecting members (221, 222, 223, 241, 242, 243) and a second side portion (240) comprising one or more attachment members (31, 32, 33). The seal (7) may be comprised between the connecting members of a first panel and attachment members of a second panel. It may be advantageous to connect a panel directly to another panel without the need for a support rib.

Referring now to FIG. 7, there is shown a light mass transit vehicle (1001). The light mass transit vehicle (1001) may include a roof portion (1002). The roof portion may include roof sheets (1003), interior ceiling trims (1004), and a roof structural frame 1005 therebetween.

An example of a roof structural frame (1005) is shown in FIG. 8. The roof structural frame (1005) may include one or more cantrails (1051). FIG. 8, for example, includes two cantrails (1051). The cantrail (1051) may extend along a length of the light mass transit vehicle (1001). The cantrail (1051) may have a uniform cross section along the length of the light mass transit vehicle (1001).

Now referring to FIG. 9, a cross section of the cantrail (1051) is illustrated adjacent a roof sheet (1003) and side wall assembly (1006). A first portion (1052) of the cantrail (1051) comprises a plurality of recesses or protrusions (1053). FIG. 9 illustrates recesses, for example. The recesses or protrusions (1053) are for engaging a plurality of protrusions or recesses respectively on a side wall assembly (1006). FIG. 9 illustrates side wall assembly protrusions, for example. Each recess or protrusion (1053) extends a length of the cantrail (1051). Each recess or protrusion (1053) may further extend an entire length of the cantrail (1051). Two or more of the cantrail recesses or protrusions (1053) are connected to support ribs (1054) of the cantrail (1051). The two or more of the cantrail recesses or protrusions (1053) may be connected to the support ribs (1054) of the cantrail (1051) such that a stress force acting at the first portion (1052) of the cantrail (1051) is dispersed to a second portion (1055) of the cantrail (1051). This may be advantageous to disperse stress through the cantrail and reduce stress concentrations, meaning less material is required for providing suitable strength and rigidity, therefore, providing a lighter cantrail.

The plurality of recesses or protrusions (1053) may be in the form of keys such that they are exclusively engageable with each other. The recesses or protrusions (1053) may be trapezoid shaped. This may provide easy assembly of the panel and ensure a strong and safe side wall assembly (1006) connection.

An internal angle of the trapezoidal recesses or protrusions (1053) may be between 35 to 55 degrees or between 125 to 145 degrees. In particular, an internal angle of the trapezoidal recesses or protrusions (1053) may be 45 or 135 degrees. It may be advantageous to reduce local stresses and provide a stronger connection to the side wall assembly (1006).

The cantrail (1051) may comprise a plurality of internal chambers. The cantrail (1051) may be formed of a metal or fibre-reinforced composite. The metal may be aluminium. The fibre-reinforced composite may be a carbon fibre-reinforced composite, for example, CFRP (carbon fibre-reinforced polymer). It may be advantageous to reduce the weight of the cantrail. Further, if the light mass transit vehicle may no longer need to support roof-mounted devices such as a pantograph, bow collector or trolley pole and it may be advantageous to provide a lightweight roof support member that is suitable for supporting a reduced load.

The plurality of recesses or protrusions (1053) may be three recesses or protrusions (1053) on a single cantrail (1051), although it will be appreciated that other numbers of recesses or protrusions (1053) may be used that provide a similar technical effect. The three recesses or protrusions (1053) may be equally spaced from each other. The three recesses or protrusions (1053) may be spaced vertically, perpendicular to a length of the cantrail (1051). It may be advantageous to provide a more secure engagement.

The plurality of recesses or protrusions (1053) may originate from a common plane of the cantrail (1051). The common plane may lie on a flat outer surface of cantrail (1051). Three or more of the plurality of recesses or protrusions (1053) may protrude or recede respectively the same amount from the common plane.

A centre axis of at least one or more apertures (not shown) may run through at least one of the plurality of recesses or protrusions (1053). The one or more apertures may provide fixing means to the roof support member (1005), for example with known mechanical means. Accordingly, fixing means may run through the side wall assembly (1006) and the plurality of recesses or protrusions (1053) and into the cantrail (1051), in particular, into an internal chamber of the cantrail (1051). Fixing means may be combined with adhesive layer covering a portion of the cantrail including the recesses or protrusions (1053). The adhesive layer may cover a mating surface of the cantrail (1051) for mating with the side wall assembly (1006). It may be further advantageous to provide a secure and safe fixing of the cantrail (1051) to the side wall assembly.

It will be appreciated that examples disclosed above may be provided in a digital format embodying the invention, for example as computer aided design or computer aided manufacturing file. The digital format may be convertible by known means into an executable file for instructing a material deposition device, for example a 3D printer, to form a physical example embodying the invention.

Referring to FIGS. 5(a) and 9, in embodiments the roof support member (5) may be the cantrail (1051). Similarly, the plurality of protrusions (211) may be the plurality of recesses or protrusions (1053), and the panel (2) or support rib (3) for a side wall assembly may be the side wall assembly (1006).

It will be appreciated that in use, the combination of the cantrail (1051) with the panel (2) and support rib (3) for a side wall assembly may provide means to build a more lightweight and modular light mass transit vehicle while maintaining the rigidity, security and strength required to support a roof and associated items fixed to the roof.

Accordingly, examples include a body for a light mass transit vehicle including: at least one panel for a side wall assembly of a light mass transit vehicle, the or each panel comprising: a first side portion comprising one or more connecting members; a second side portion comprising one or more connecting members; a top portion separating the first and second side portions and comprising a plurality of protrusions or recesses configured to interlock with a roof support member of the vehicle, each protrusion or recess extending substantially from the first side portion to the second side portion; and a bottom portion configured to connect to a base support member of the vehicle; and further including at least one cantrail for a light mass transit vehicle, a first portion of the cantrail comprising a plurality of recesses or protrusions for engaging a plurality of protrusions or recesses respectively on the side wall assembly, each recess or protrusion extending a length of the cantrail, wherein two or more of the cantrail recesses or protrusions are connected to internal support ribs of the cantrail such that a stress force acting at the first portion of the cantrail is dispersed to a second portion of the cantrail, wherein the cantrail is the roof support member and is configured to interlock the or each panel via complementary protrusions or recesses.

In examples and embodiments, a skeleton structure including one or more head modules, the cantrail or roof support member, and the base support member may be formed. This may define a length of the light mass transit vehicle. This may be advantageous as sections of the skeleton structure may easily be removed or added to make a desired length and/or position doors in a desired way. A number of side wall panels and ribs may be added as desired further improving ease of assembly and providing flexibility on assembly design. A roof assembly can then be added supported by two or more of the cantrails and side wall assemblies. In contrast, current methods generally extrude a whole-body shell being limited to that length after fabrication, as well as having manufacturing limitations in the forming of a body shell as a whole.

While the invention has been illustrated and described in detail in the drawings and preceding description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Each feature of the disclosed embodiments may be replaced by alternative features serving the same, equivalent or similar purpose, unless stated otherwise. Therefore, unless stated otherwise, each feature disclosed is one example of a generic series of equivalent or similar features.

In the claims, the word “comprising” does not exclude other elements or steps, and the indefinite article “a” or “an” does not exclude a plurality. Any reference signs in the claims should not be construed as limiting the scope.

1. A panel for a side wall assembly of a light mass transit vehicle, comprising:
a first side portion comprising one or more connecting members;
a second side portion comprising one or more connecting members;
a top portion separating the first and second side portions and comprising a plurality of protrusions configured to interlock with a roof support member of the vehicle, each protrusion extending substantially from the first side portion to the second side portion; and
a bottom portion configured to connect to a base support member of the vehicle.

2. The panel of claim 1, wherein the connecting members are configured to connect to attachment members of a support rib.

3. The panel of claim 1 or 2, wherein the one or more connecting members of the first side portion are three or more connecting members and are spaced in three distinct groups.

4. The panel of claim 1, 2 or 3, wherein the one or more connecting members of the second side portion are three or more connecting members and are spaced in three distinct groups.

5. The panel of claim 3 or 4, wherein the three distinct groups comprise two groups with one connecting member and one group of more than one connecting members.

6. The panel of claim 5, wherein the one group of more than one connecting members comprises eight connecting members.

7. The panel of any of claims 1 to 6, wherein each protrusion further comprises one or more recesses.

8. The panel of any of claims 1 to 7, wherein the plurality of protrusions are three protrusions.

9. The panel of claim 8, wherein the three protrusions are equally spaced from each other.

10. The panel of any of claims 1 to 9, wherein the plurality of protrusions originate from a common plane.

11. The panel of any of claims 1 to 10, wherein the top portion further comprises one or more apertures for fixing means for the roof support member.

12. The panel of claim 11, wherein a centre axis of at least one of the one or more apertures runs through at least one of the plurality of protrusions.

13. The panel of any of claims 1 to 12, wherein the bottom portion further comprises one or more apertures for fixing means for the base support member.

14. The panel of claim 13, wherein three or more of the one or more apertures are arranged in a line at a 35 to 55 degree angle to the vertical.

15. The panel of any of claims 1 to 14, further comprising a seat rail extending substantially from the first side portion to the second side portion.

16. The panel of any of claims 1 to 15, further comprising a trapezoidal window wherein a top base side is longer than a bottom base side.

17. The panel of any of claims 2 to 16, wherein the connecting members are keyed for inserting into the attachment members of a support rib.

18. A support rib for a side wall assembly of a light mass transit vehicle, comprising:
a first side portion comprising one or more attachment members;
a second side portion comprising one or more attachment members;
a top portion separating the first and second side portions and comprising a plurality of protrusions configured to interlock with a roof support member of the vehicle, each protrusion extending from the first side portion to the second side portion; and
a bottom portion configured to connect to a base support member of the vehicle.

19. The support rib of claim 18, wherein the attachment members are configured to attach to connecting members of a panel.

20. The support rib of claim 18 or 19, wherein the first and second side portions further comprise any of the features of the first and second side portions of claims 2 to 6 for connecting the support rib to the panel.

21. The support rib of claim 18, 19 or 20, wherein the top portion further comprises any of the features of the top portion of claims 7 to 12 for connecting to the roof support member.

22. The support rib of any of claims 18 to 21, wherein the bottom portion further comprises one or more apertures for fixing means for the base support member.

23. The support rib of any of claims 19 to 22, wherein the attachment members are keyed for receiving the connecting members of the panel.

24. The support rib of any of claims 18 to 23 wherein a single support rib is configured to connect to two of the panels of any of claims 1 to 17.

25. A vehicle comprising the panel of any of claims 1 to 17 and the support rib of any of claims 18 to 24.

26. A cantrail for a light mass transit vehicle, a first portion of the cantrail comprising a plurality of recesses or protrusions for engaging a plurality of protrusions or recesses respectively on a side wall assembly, each recess or protrusion extending a length of the cantrail, wherein two or more of the cantrail recesses or protrusions are connected to internal support ribs of the cantrail such that a stress force acting at the first portion of the cantrail is dispersed to a second portion of the cantrail.

27. The cantrail of claim 26, wherein the plurality of recesses or protrusions are in the form of keys.

28. The cantrail of claim 26 or 27, wherein the recesses or protrusions are trapezoid shaped.

29. The cantrail of claim 28, wherein an internal angle of the trapezoidal recesses or protrusions is 35 to 55 degrees or 125 to 145 degrees.

30. The cantrail of claim 29, wherein an internal angle of the trapezoidal recesses or protrusions is 45 or 135 degrees.

31. The cantrail of any preceding claim, further comprising a plurality of internal chambers defined by the support ribs.

32. The cantrail of any of claims 26 to 31, the cantrail being formed of a metal or fibre-reinforced composite.

33. The cantrail of claim 32, wherein the metal is aluminium or the fibre-reinforced composite is CFRP respectively.

34. The cantrail of any of claims 26 to 33, wherein the plurality of recesses or protrusions are three recesses or protrusions on a single cantrail.

35. The cantrail of claim 34, wherein the three recesses or protrusions are equally spaced away from each other on a first surface of the cantrail.

36. A computer-readable medium comprising instructions that when executed instructs a material deposition device to form the cantrail of any of claims 26 to 35.

37. A body for a light mass transit vehicle, including:
at least one panel for a side wall assembly of a light mass transit vehicle, the or each panel comprising:
a first side portion comprising one or more connecting members;
a second side portion comprising one or more connecting members;
a top portion separating the first and second side portions and comprising a plurality of protrusions or recesses configured to interlock with a roof support member of the vehicle, each protrusion or recess extending substantially from the first side portion to the second side portion; and
a bottom portion configured to connect to a base support member of the vehicle; and
further including
at least one cantrail for a light mass transit vehicle, a first portion of the cantrail comprising a plurality of recesses or protrusions for engaging a plurality of protrusions or recesses respectively on the side wall assembly, each recess or protrusion extending a length of the cantrail, wherein two or more of the cantrail recesses or protrusions are connected to internal support ribs of the cantrail such that a stress force acting at the first portion of the cantrail is dispersed to a second portion of the cantrail, wherein the cantrail is the roof support member and is configured to interlock the or each panel via complementary protrusions or recesses.

38. The body of claim 37, further including at least one support rib for a side wall assembly of a light mass transit vehicle, the or each support rib including a top portion, the top portion including the protrusions or recesses and configured to interlock with the at least one cantrail.

39. A light mass transit vehicle including the body of claim 37 or 38.

40. A light mass transit vehicle including at least one panel according to any one of claims 1 to 17.

41. A light mass transit vehicle including at least one support rib according to any one of claims 18 to 24.

42. A light mass transit vehicle including the cantrail of any one of claims 26 to 35.
